(19) United States
(12) Patent Application Publication
(10) Pub. No.: US 2014/0257701 A1
(43) Pub. Date: Sep. 11, 2014

(54) OUTPUT COMPRESSION FOR GEOLOGICAL STRATA PHYSICAL PROPERTY MODELING

(71) Applicant: SCHLUMBERGER TECHNOLOGY CORPORATION, Sugar Land, TX (US)

(72) Inventors: Adrian Kleine, Aachen (DE); Armin I. Kauerauf, Aachen (DE); Michael De Lind Van Wijngaarden, Vancouver (CA)

(73) Assignee: SCHLUMBERGER TECHNOLOGY CORPORATION, Sugar Land, TX (US)

(21) Appl. No.: 14/200,337

(22) Filed: Mar. 7, 2014

Related U.S. Application Data
(60) Provisional application No. 61/775,952, filed on Mar. 11, 2013.

(51) Int. Cl. G01V 99/00

(52) U.S. Cl. CPC G01V 99/00
USPC 702/5

(57) ABSTRACT

Methods, systems, and computer-readable media for compressing topological grid data for layered geological strata are described. The techniques include obtaining topological grid data for a layered geological structure, where the topological grid data includes a plurality of cell representations, a majority of the cell representations including at least one data value, where the topological grid data includes at least one pinch-out cell representation lacking a data value. The techniques also include interpolating a data value for the at least one pinch-out cell representation to produce interpolated topological grid data. The techniques also include transforming the interpolated topological grid data to obtain frequency domain interpolated topological grid data. The techniques also include truncating ordered coefficients of the frequency domain interpolated topological grid data to obtain truncated frequency domain interpolated topological grid data. The techniques also include storing on a non-transitory storage medium the truncated frequency domain interpolated topological aid data.

### CROSS-REFERENCE TO RELATED APPLICATION

This application claims priority to U.S. Provisional Patent Application Ser. No. 61/775,952, filed on Mar. 11, 2013. The entirety of this provisional application is incorporated herein by reference.

### BACKGROUND

Computer-implemented techniques for modeling physical properties of geological strata are known. Such techniques can model physical properties such as temperature, petroleum saturation, and pore pressure. Known models can compute such physical properties for each cell in an imposed grid of hundreds of millions of cells. A simple model that tracks one hundred million cells, with four bytes of data per cell, may yield 0.4 gigabytes of raw output data for each output event and physical quantity. Thus, a typical model of twenty-five output events and one hundred different physical quantities can output data on the order of one terabyte. Although it is possible to set up a data storage environment that can handle output data of this order of magnitude, significant efforts are needed to achieve this.

### SUMMARY

Embodiments of the present disclosure may include systems, methods, and computer-readable media for compressing topological grid data representing. e.g., an output from a physical property model of geological strata. In one embodiment, a method may employ a computerized system that obtains output data from such a model. The method may interpolate data for cells that represent strata “pinch-outs”. The method may then transform the interpolated topological grid data and truncate ordered lists of the resulting frequency domain coefficients to achieve reduced-size data with a known error rate. The method may capitalize on the relative smoothness of the physical property values in the model.

This summary is provided to introduce some of the subject matter described below and is not to he considered limiting.

### BRIEF DESCRIPTION OF THE DRAWINGS

The accompanying drawings which are incorporated in and constitute a part of this specification, illustrate embodiments of the present teachings and together with the description, serve to explain the principles of the present teachings. In the figures:

FIG. 1 illustrates an output of a temperature model according to an embodiment.

FIG. 2 illustrates an output of a petroleum saturation model according to an embodiment.

FIG. 3 illustrates a layered geological formation with an imposed topological grid according to an embodiment.

FIG. 4 illustrates schematically a topological grid according to an embodiment.

FIG. 5 is a flowchart for a method according to an embodiment.

FIG. 6 illustrates a two-dimensional block output of a temperature model in the spatial domain.

FIG. 7 illustrates a two-dimensional block output of a temperature model in the frequency domain.

FIG. 8 illustrates a schematic view of a processor system according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

Disclosed herein are techniques for compressing the data output from physical property models of geological strata. Such techniques may capitalize on strong correlations among physical properties of spatially close cells and provide efficient compression schemes particularly suited for the outputs of physical property models of geological strata. Example process techniques can include the steps of obtaining topological grid data, interpolating data values for inactive cells, transforming the data, and truncating coefficients to obtain compressed data. These and other steps are discussed in detail below.

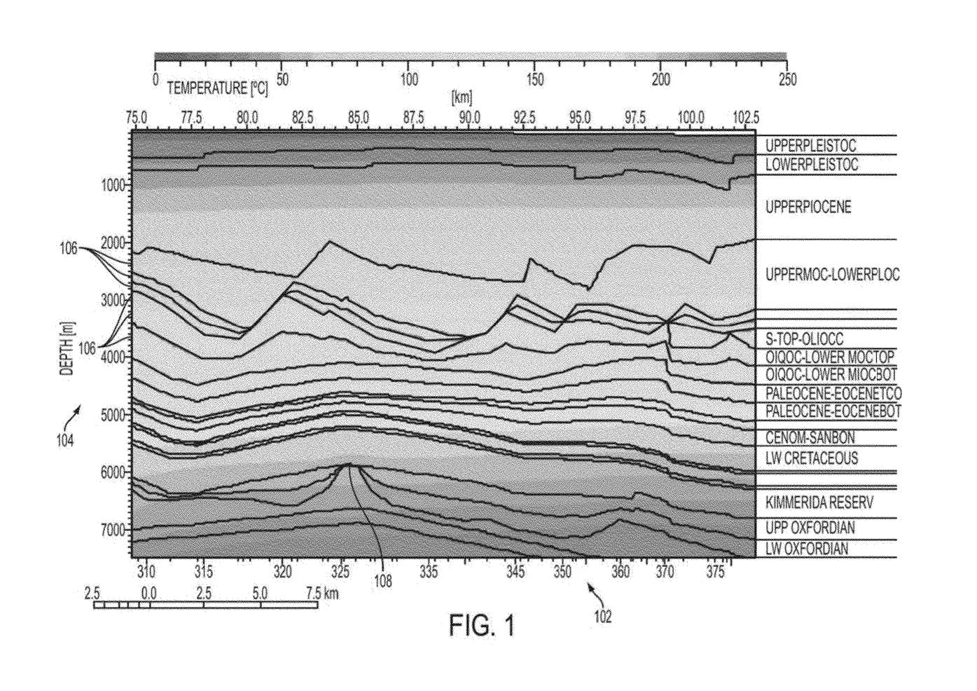

FIG. 1 illustrates an output of a geological strata temperature model according to an embodiment. More particularly, FIG. 1 illustrates a two-dimensional cross-section of a three-dimensional output of a model of temperature for a three-dimensional portion of geological strata. The x-axis 102 of the output represents transverse location, and the y-axis 104 represents depth. Temperature is represented by shading. Note that while FIG. 1 illustrates a two-dimensional view, embodiments may handle data relating to a three-dimensional strata portion.

The dominating geometrical structures considered by geological strata models (e.g., temperature models) are geological layers or “strata”. A stratum can be defined as rock deposited during a specific geological time span (e.g., the Jurassic period, 200-145 million year ago). FIG. 1 illustrates strata (e.g., strata 106 ) as overlaid on the model output.

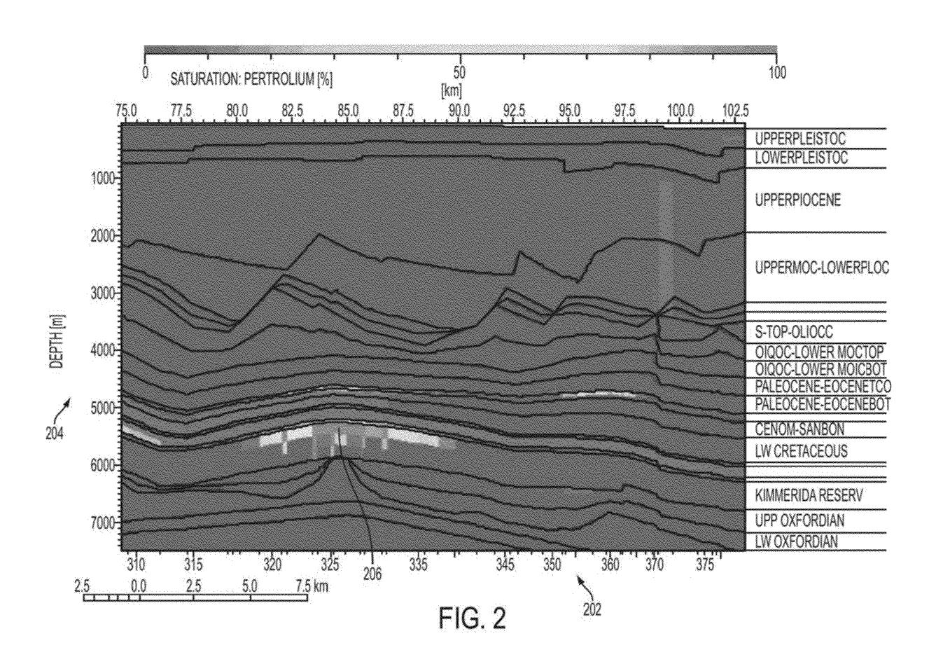

FIG. 2 illustrates an output of a petroleum saturation model according to an embodiment. Similar to FIG. 1, FIG. 2 depicts a two-dimensional cross-section of a three-dimensional output of a model of petroleum saturation for a portion of geological strata. The x-axis 202 of the output represents transverse location, and the y-axis 104 represents depth. Petroleum saturation is represented by shading. Again, though FIG. 2 illustrates a two-dimensional section, embodiments may consider three-dimensional volumes.

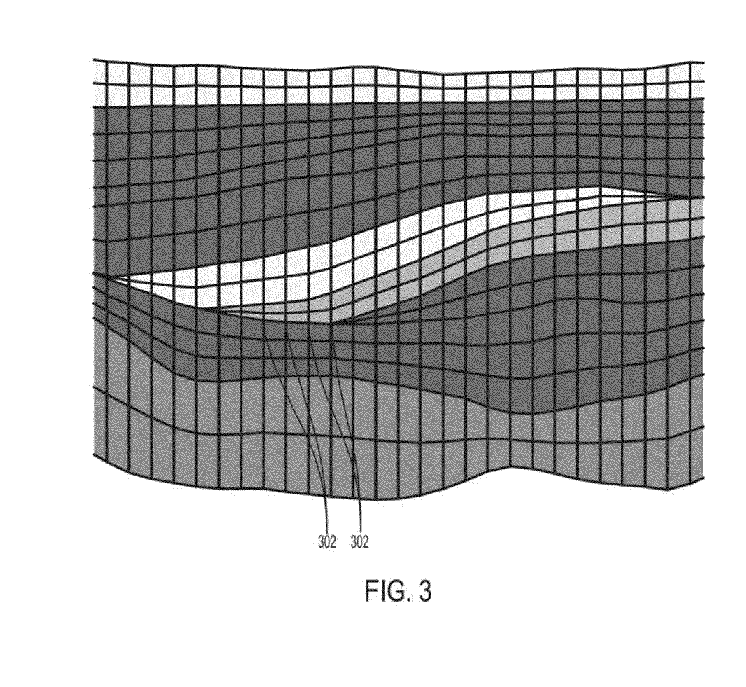

FIG. 3 illustrates a layered geological formation with an imposed topological grid according to an embodiment. In particular, FIG. 3 depicts an imposed grid structure utilized by models according to various embodiments. Some embodiments consider models that utilize a grid aligned to strata, as properties of rocks within the same layer are often similar. The grid may be structured and based on hexahedrons. Each cell can uniquely be addressed by a triple (i₁,i₂,i₃) where 0≦i₁<N₁, 0≦i₂<N₂, and 0≦i₃<N₃ for fixed N₁, N₂ and N₃. The total number of cells in the model is then given by N₁×N₂×N₃. Each modeled physical property (which exists on the real-space grid) is associated with the topological grid structure, e.g., one physical quantity value a_{i1,i2,i3} for each (i₁,i₂,i₃) triple.

In some embodiments, the model or the embodiment groups cells into larger blocks. For a fixed block size M, a model or an embodiment, can divide the grid into blocks including M³ cells. For example, for M=16, and for data with 1024×1024×96 cells total, the data may be quantized into 64×64×6 blocks. Such quantization can be used to simplify and break up modeling and/or compression calculations.

Note that, in general, specific strata do not exist everywhere. For example, it can happen that layers have not been deposited at some locations, or might have been eroded at earlier times. The lack of a particular layer at a particular location is referred to as a “pinch-out”. FIG. 3 depicts example pinch-outs 302. As discussed herein, some embodiments account for the presence of pinch-outs by interpolating values.

The imposed grid depicted in FIG. 3 is topological, as opposed to topographical or Euclidean. For example, the grid of FIG. 3 includes both evenly-spaced vertical grid lines, and roughly horizontal grid lines defined according to the interfaces between strata. Because FIG. 3 shows a two-dimensional cross-section for purposes of illustration, lines can be used to demarcate cells; in an actual use case, however, planes or general surfaces may be used to partition a considered volume into hexahedral cells. Thus, FIG. 3 depicts cross-sections of three-dimensional cells, where each cell cross-section is defined by a pair of vertical grid lines and either a pair of roughly-horizontal grid lines defined by adjacent strata, or a single roughly-horizontal grid line that indicates the presence of a pinch-out.

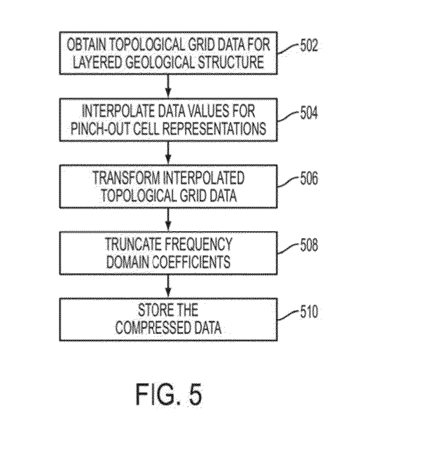

Cells that represent pinch-outs are referred to as “inactive” and may not have physical property value(s) initially estimated for them by the model. However, models may interpolate physical values for inactive cells based on values from the surrounding cells as discussed below (e.g., in reference to block 504 of FIG. 5). In general, inactive cells may have zero volume.

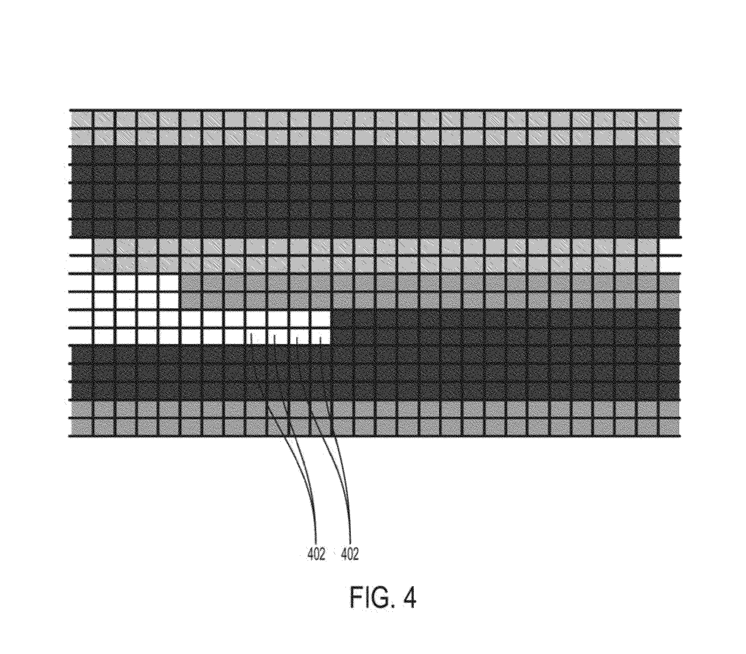

FIG. 4 illustrates schematically a topological grid according to an embodiment. In particular, FIG. 4 depicts the topological grid of FIG. 3, but with inactive cells 402 explicitly depicted. That is, the topological grid of FIG. 3 is identical to the topological grid of FIG. 4, except that the pinch-out cells are expanded and shown without shading to indicate their lack of physical quantity values in FIG. 4.

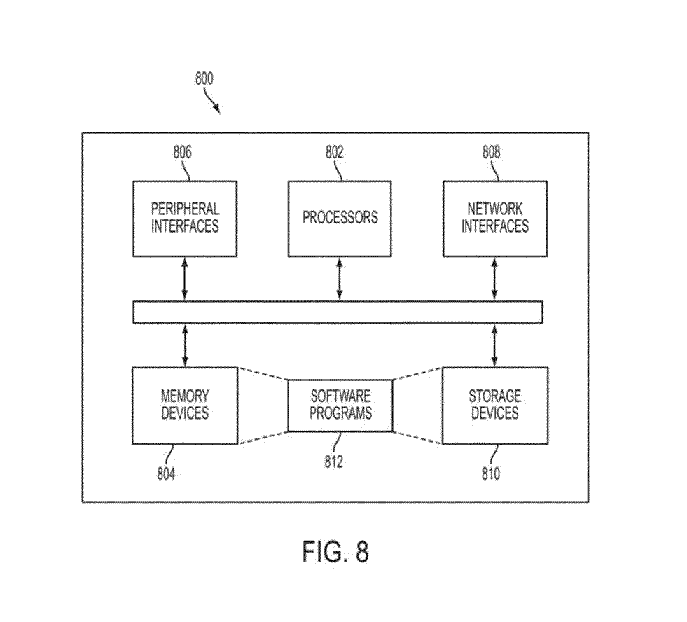

FIG. 5 is a flowchart for a method according to an embodiment. The method of FIG. 5 may be implemented by one or more programmed processors as discussed below in reference to FIG. 8. The method of FIG. 5 may be used to compress data output by models of physical properties of geological strata.

At block 502, the method obtains topological grid data for a layered geological structure. The topological grid data may be output from a model of physical properties of the geological strata. The grid data can include, for example, physical quantities for each cell defined by the topological grid.

The data may be obtained in various ways. For example, an embodiment may be included as part of an implementation of the model itself, such that the model provides the data to the embodiment within an electronic communications channel. In such configurations, the model may produce blocks of raw data, and the embodiment may be applied block-wise to compress the data. As another example, the data may be obtained from a model that is logically and/or physically disjoint from the embodiment. In such configurations, the embodiment may obtain the data from the model over a network such as a local area network or the internet. As yet another example, the topological grid data may be obtained from a source other than the output of a model of physical properties of geological strata.

At block 504, the method interpolates data values for pinch-out cell representations. In general, inactive cells, which represent pinch-out locations, have undefined values for some or all modeled physical quantities. Because then next block in the method of FIG. 5 (i.e., block 506) employs a transform that generally utilizes values for all cells, the operation of block 504 provides interpolated values for cells that initially lack such values.

An example suitable interpolation technique for block 504 is a Laplace interpolation scheme. Laplace interpolation may use a mapping of the interpolation problem to a Laplace equation, where all defined values are taken as boundary conditions. The Laplace equation may be solved on the topological grid (e.g., illustrated in FIGS. 3 and 4). Solving the Laplace equation given by ∇²a=0 using known techniques provides interpolated values for all undefined (i.e., inactive cells). Further, fast numerical algorithms exist to solve the Laplace equation, for example, algebraic multi-grid methods, allowing for fast implementations. Though Laplace interpolation is provided as an example, other interpolation schemes may be used in addition or in the alternative, by way of non-limiting example: polynomial interpolation, splines, Poisson interpolation, minimum curvature interpolation, interpolation using rational functions, etc.

After block 504, the resulting interpolated values are relatively smooth, which is advantageous for the subsequent steps of blocks 506 and 508. Smooth values are also advantageous for obtaining good compression ratios. The output of block 504 may be referred to as interpolated topological grid data.

At block 506, the method transforms the interpolated topological grid data from the spatial domain to the frequency domain (Although the terra “frequency domain” can refer to units of quantity per time, those of skill in the art understand that it can also refer to the output of a transform such as a Fourier transform, regardless as to the type of units used for the input data.) A Fourier transform may be used for block 506 to transform the data values to the frequency domain by calculating according to, by way of non-limiting example, the following.

bₖ_{₁}ₖ_{₂}ₖ_{₃}=Σᵢ_{₁}₌₀^{M}Σᵢ_{₂}₌₀^{M}Σᵢ_{₃}₌₀^{M}Cₖ_{₁}ᵢ_{₁}Cₖ_{₂}ᵢ_{₂}Cₖ_{₃}ᵢ_{₃}aᵢ_{₁}ᵢ_{₂}ᵢ_{₃} (1)

In Equation (1) above, the term bₖ_{₁}ₖ_{₂}ₖ_{₃} represents a Fourier coefficient, the term M represents block size (i.e., M×M×M), the term aᵢ_{₁}ᵢ_{₂}ᵢ_{₃} represents the values for the considered physical quantity, and each Cₖᵢ may be provided by a discrete cosine transformation of type II according to, by way of non-limiting example, Equation (2) below.

$${C}_{ki} = cos ( \frac{π}{M} [ i + \frac{1}{2} ] k ) \qquad ( 2 )$$

In Equation (2), cos represents the trigonometric cosine function, and M represents block size as discussed above in reference to Equation (1).

Block 506 is not limited to this particular transformation. Depending on the input data, other transformations such as other discrete cosine transformations or discrete sine transformations may be used. Discrete wavelets transformations using, e.g., Haar, Daubechies, or Cohen-Daubechies-Feauveau wavelets are also suitable transformations.

One the data is transformed, the output of block 506 may be referred to as frequency domain interpolated topological grid data.

At block 508, the method truncates the transformed coefficients to reduce the size of the data. In general, after applying block 506, only a relative few, mostly low-frequency, components have significant weight. Accordingly, truncating the coefficients to eliminate those that represent negligible components can efficiently compress the data without losing significant information.

Thus, block 508 may first sort or re-order the coefficients using a suitable ordering. The chosen ordering may be fixed for all block, but may differ for different physical quantities or events. The ordering may be selected so that, for the most part, the absolute value of the reordered coefficients is decreasing. Because, generally, only the low-frequency components have significant weights, the ordering may move the low-frequency components to the front and the high-frequency ones to the back according to the ordering. As an example three-dimensional reordering may proceed according to the pattern established by the following example sequence: b₀₀₀, b₁₀₀, b₀₁₀, b₀₀₁, b₂₀₀, b₁₁₀, b₁₀₁, b₀₂₀, b₀₁₁, b₀₀₂,etc.

After the coefficients are re-ordered, block 508 truncates them to retain the first N coefficients; all coefficients beyond N in the ordering are discarded. The error introduced by this compression can be calculated by applying the inverse transformation and comparing the results to the input data. Block 508 can select a suitable value for N such that the maximum error introduced by the compression scheme is below a specific error limit (e.g., a percentage). that is, embodiments may prompt a user to enter an error limit, and the method can determine an appropriate value for N that achieves the limit while reducing the number of retained coefficients as much as possible as constrained by the specified error limit.

The output of block 508 may be referred to as truncated frequency domain interpolated topological grid data, or simply “compressed data”.

At block 510, the method stores the compressed data. That is, for each block, the first N of the coefficients are stored. Other relevant data (e.g., data representing the topological grid) may be stored as well. The data may be stored in persistent memory such as hard disk, flash memory, tape drive, or any other electronic storage technique that can accommodate bulk data. The data may be transmitted over a network such as a local area network or the internet prior to storage.

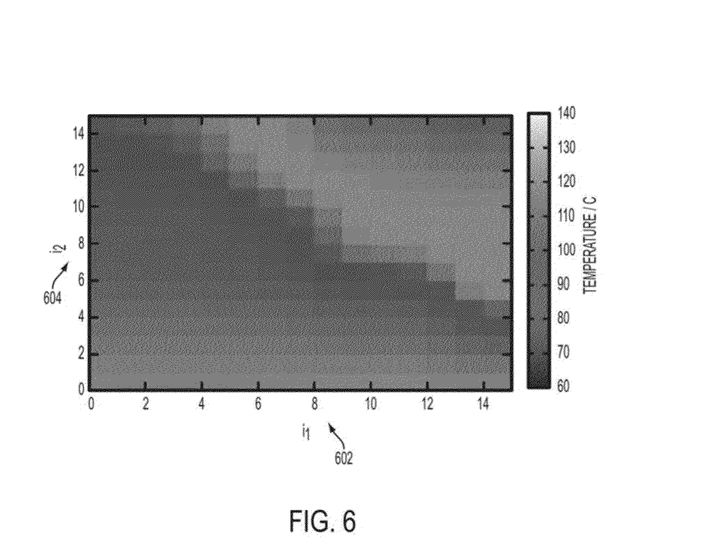

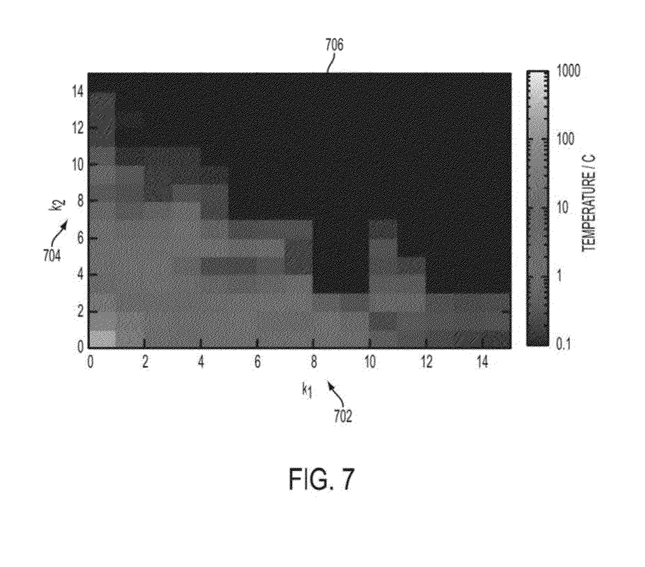

Collectively, FIGS. 6 and 7 pictorially illustrate in part how the disclosed technique compresses data. In particular, FIG. 6 illustrates a two-dimensional block output of a geological strata temperature model in the spatial domain, and FIG. 7 illustrates the same block after being subjected to transformation and truncation operations as disclosed herein.

FIG. 6 thus illustrates a typical temperature distribution in a two-dimensional 16×16 cross-section of a block of geological strata, e.g., as output from a geological strata physical property model. The x-axis 602 and y-axis 604 of FIG. 6 depict block addresses in the plane defined by a fixed i₃, namely, i₁ and i₂ of the triples respectively. Temperature is represented by shading. As shown, temperature is smooth and generally increasing with depth. Additionally, as shown, only small lateral variations in temperature are present.

FIG. 7 shows the result of transforming (e.g., per block 606 of FIG. 6) and truncating (e.g., per block 608 of FIG. 6) the data of FIG. 6. In FIG. 6, the coefficient index k₃ is fixed, and the x-axis and y-axis represent coefficient indices k₁ and k₂, respectively. The shading represents the value of coefficient bₖ_{₁}ₖ_{₂}ₖ_{₃} (see Equation (1), above). Every coefficient value smaller than 0.1 is plotted in black to illustrate the truncation operation pictorially. As shown, only a few low-frequency components exhibit significant contributions, whereas the high-frequency parts are (almost) vanishing. This is an expected result as the temperature distribution in this example is relatively smooth.

For the compression illustrated by FIGS. 6 and 7, it is possible to achieve a compression rate of 1:6 using an embodiment, where the errors did not exceed 0.2° C., which is better than the simulation accuracy of many models. This is a typical compression rate for dense continuous properties like temperatures, pressures, etc., which are of the order of 1:5-1:10, while for properties which are only non-zero in small areas of the model (e.g. petroleum saturations, see FIG. 2) compression rates of 1:100 and more are achievable using the disclosed techniques.

Numerous alterations and extensions of the described compression techniques are possible. For example, embodiments may employ a transformation other than a discrete cosine transformation for block 506 of FIG. 5, e.g., a discrete wavelet transformation.

Furthermore, embodiments may consider and utilize dimensions greater than three. For example, geological property models of geological strata usually consider many different hydrocarbon components (e.g., up to 100), such as methane, ethane, propane, etc. The different hydrocarbon components can be enumerated, for instance 0 for methane, 1 for ethane, and so on. For any hydrocarbon component-related output, e.g., the mass of a specific hydrocarbon component per cell, the component index can be considered as additional dimensions, as opposed to values mapped from a three-dimensional cell. This means, for example, instead of mapping a particular cell (i₁, i₂, i₃) to the mass of a particular hydrocarbon component (with index j) aᵢ_{₁}ᵢ_{₂}ᵢ_{₃}^{(j)}, represented symbolically as (i₁, i₂, i₃)→aᵢ_{₁}ᵢ_{₂}ᵢ_{₃}^{(j)}, embodiments may consider the hydrocarbon index as a fourth dimension, for example, represented symbolically as (i₁, i₂, i₃, j). Additionally, or in the alternative, the geological time can be interpreted as additional dimension.

When both time and temperature are taken into account as dimensions, the input data can be five-dimensional, represented symbolically as (i₁,i₂,i₃,i₄, i₅), where (i₁,i₂,i₃) enumerates the topological grid cell, i₄ the hydrocarbon component, and i₅ the time-step. In such an embodiment, a five-dimensional discrete cosine transform can be utilized. Using this technique can increase the compression ratios obtained by the considered algorithm substantially

FIG. 8 illustrates a schematic view of a processor system 800 according to an embodiment. In general, embodiments may include one or more processor (i.e., computing) systems for implementing one or more embodiments of the disclosed techniques (e.g., the method of FIG. 5). The processor system 800 may include one or more processors 802 of varying core (including multiple cores) configurations and clock frequencies. The one or more processors 802 may be operable to execute instructions, apply logic, etc. It will be appreciated that these functions may be provided by multiple processors or multiple cores on a single chip operating in parallel and/or communicably linked together.

The processor system 800 may also include a memory system, which may be or include one or more memory devices and/or computer-readable media 804 of varying physical dimensions, accessibility, storage capacities, etc. such as flash drives, hard drives, disks, random access memory, etc., for storing data, such as images, files, and program instructions for execution by the processor 802. In an embodiment, the computer-readable media 804 may store instructions that, when executed by the processor 802, are configured to cause the processor system 800 to perform operations. For example, execution of such instructions may cause the processor system 800 to implement one or more portions and/or embodiments of the method of FIG. 5 described above.

The processor system 800 may also include one or more network interfaces 808. The network interfaces 808 may include any hardware, applications, and/or other software. Accordingly, the network interfaces 808 may include Ethernet adapters, wireless transceivers, PCI interfaces, and/or serial network components, for communicating over wired or wireless media using protocols, such as Ethernet, wireless Ethernet, etc.

The processor system 800 may further include one or more peripheral interfaces 806, for communication with a display screen, projector, keyboards, mice, touchpads, sensors, other types of input and/or output peripherals, and/or the like. In some implementations, the components of processor system 800 need not be enclosed within a single enclosure or even located in close proximity to one another, but in other implementations, the components and/or others may be provided in a single enclosure.

The memory device 804 may he physically or logically arranged Of configured to store data on one or more storage devices 810. The storage device 810 may include one or more file systems or databases in any suitable format. The storage device 810 may also include one or more software programs 812, which may contain interpretable or executable instructions for performing one or more of the disclosed processes. When requested by the processor 802, one or more of the software programs 812, or a portion thereof, may be loaded from the storage devices 810 to the memory devices 804 for execution by the processor 802.

Those skilled in the art will appreciate that the above-described componentry is merely one example of a hardware configuration, as the processor system 800 may include any type of hardware components, including any necessary accompanying firmware or software, for performing the disclosed implementations. The processor system 800 may also be implemented in part or in whole by electronic circuit components or processors, such as application-specific integrated circuits (ASICs) or field-programmable gate arrays (FPGAs).

The foregoing description of several possible embodiments has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 800 may be used to execute programs according to instructions received from another program or from another computing system altogether. Similarly, commands may he received, executed, and their output returned entirely within the processing and/or memory of the processor system 800. Accordingly, neither a visual interface command terminal nor any terminal at all is strictly necessary for performing the described embodiments.

Further, processor system 800 may implement a physical property model of geological strata as referred to herein. That is, the same processor system that implements the compression scheme for output data from a physical property model of geological strata may also implement the physical property model itself. In such an arrangement, block 402 of FIG. 5 may be achieved by accessing stored or streamed data in the same physical system.

The steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents.

1. A computer implemented method for compressing topological grid data for a geological structure, comprising:
obtaining topological grid data for a geological structure, wherein the topological grid data comprises a plurality of cell representations, a majority of the cell representations comprising at least one data value, wherein the topological grid data comprises at least one pinch-out cell representation lacking the at least one of data value;
interpolating, using an electronic processor, a data value for the at least one pinch-out cell representation to produce interpolated topological grid data;
transforming, using an electronic processor, the interpolated topological grid data to obtain frequency domain interpolated topological grid data;
truncating, using an electronic processor, ordered coefficients of the frequency domain interpolated topological grid data to obtain truncated frequency domain interpolated topological grid data; and
storing on a non-transitory storage medium the truncated frequency domain interpolated topological grid data.

2. The method of claim 1, wherein the interpolating comprises applying a Laplace interpolation scheme.

3. The method of claim 1, wherein the transforming comprises applying at least one of: a Fourier transform, a discrete cosine transform, a discrete sine transform, or a discrete wavelet Transform.

4. The method of claim 1, wherein the at least one data value represents a physical property selected from the group consisting of: temperature, pore pressure, hydrocarbon saturation, hydrocarbon mass, and rock stress.

5. The method of claim 1, wherein the truncating comprises re-ordering the coefficients.

6. The method of claim 1, further comprising calculating a truncation point based on a maximum introduced error.

7. The method of claim 1, wherein the obtaining comprises obtaining from a model of at least one physical property of geological strata.

8. A system for compressing topological arid data for a layered geological structure, comprising:
a persistent memory; and
at least one electronic processor programmed to perform the steps of:
obtaining topological grid data for a layered geological structure, wherein the topological grid data comprises a plurality of cell representations, a majority of the cell representations comprising at least one data value, wherein the topological grid data comprises at least one pinch-out cell representation lacking the at least one of data value;
interpolating, using the at least one electronic processor, a data value for the at least one pinch-out cell representation to produce interpolated topological grid data;
transforming, using the at least one electronic processor, the interpolated topological grid data to obtain frequency domain interpolated topological grid data;
truncating, using the at least one electronic processor, ordered coefficients of the frequency domain interpolated topological grid data to obtain truncated frequency domain interpolated topological grid data; and
storing on the persistent memory the truncated frequency domain interpolated topological grid data.

9. The system of claim 8, wherein the at least one electronic processor is further configured to apply a Laplace interpolation scheme.

10. The system of claim 8, wherein the at least one electronic processor is further configured to apply at least one of: a Fourier transform a discrete cosine transform, a discrete sine transform, and a discrete wavelet transform.

11. The system of claim 8, wherein the at least one data value represents a physical property selected from the group consisting of: temperature, pore pressure, hydrocarbon saturation, hydrocarbon mass, and rock stress.

12. The system of claim 8, wherein the at least one electronic processor is further configured to re-order the coefficients.

13. The system of claim 8, wherein the at least one electronic processor is further configured to calculate a truncation point based on a maximum introduced error.

14. The system of claim 8, wherein the at least one electronic processor is further configured to obtain the topological grid data from a model of at least one physical property of geological strata.

15. A computer readable medium comprising instructions which, when executed by at least one electronic processor, cause the at least one electronic processor to:
obtain topological grid data for a layered geological structure, wherein the topological grid data comprises a plurality of cell representations, a majority of the cell representations comprising at least one data value, wherein the topological grid data comprises at least one pinch-out cell representation lacking the at least one of data value;
interpolate, using the at least one electronic processor, a data value for the at least one pinch-out cell representation to produce interpolated topological grid data;
transform, using the at least one electronic processor, the interpolated topological grid data to obtain frequency domain interpolated topological grid data;
truncate, using the at least one electronic processor, ordered coefficients of the frequency domain interpolated topological grid data to obtain truncated frequency domain interpolated topological grid data; and
store on a non-transitory storage medium the truncated frequency domain interpolated topological grid data.

16. The computer readable medium of claim 15, further comprising instructions which, when executed by the at least one electronic processor, further cause the at least one electronic processor to apply a Laplace interpolation scheme.

17. The computer readable medium of claim 15, further comprising instructions which, when executed by the at least one electronic processor, further cause the at least one electronic processor to apply at least one of: a Fourier transform, a discrete cosine transform, a discrete sine transform, and a discrete wavelet transform.

18. The computer readable medium of claim 15, wherein the at least one data value represents a physical property selected from the group consisting of: temperature, pore pressure, hydrocarbon saturation, hydrocarbon mass, and rock stress.

19. The computer readable medium of claim 15, further comprising instructions which, when executed by the at least one electronic processor, further cause the at least one electronic processor to re-order the coefficients.

20. The computer readable medium of claim 15, further comprising instructions which, when executed by the at least one electronic processor, further cause the at least one electronic processor to calculate a truncation point based on a maximum introduced error.
